(19) United States
(12) Patent Application Publication
(10) Pub. No.: US 2015/0213381 A1
(43) Pub. Date: Jul. 30, 2015

(54) SYSTEM, APPARATUS AND METHOD FOR PERFORMING ENTERPRISE ANALYSIS OF INFORMATION TECHNOLOGY PROVISIONS AND COSTS

(71) Applicant: Kenji Hagiwara, Edgewater, NJ (US)

(72) Inventor: Kenji Hagiwara, Edgewater, NJ (US)

(73) Assignee: RICOH COMPANY, LTD., Tokyo (JP)

(21) Appl. No.: 14/164,746

(22) Filed: Jan. 27, 2014

(51) Int. Cl. G06Q 10/06

(52) U.S. Cl. CPC G06Q 10/063

(57) ABSTRACT

Tools (such as system, apparatus and method) are provided for performing analysis of information technology provisions and/or costs, for an enterprise or another organization having facilities at multiple sites and in multiple countries. For example, such tools maintain plural device price tables expressing collected device price data in plural currencies. Thus, a user in any of the multiple countries can perform an enterprise analysis, based on one of the plural currencies.

### TECHNICAL FIELD

This disclosure relates to tools (for example, systems, apparatuses, methodologies, computer programs, etc.) for performing an enterprise analysis of information technology provisions and/or costs, for an enterprise or another organization.

### BACKGROUND

In the current information age, information technology (IT) tools are extensively used in enterprises and other organizations in order to facilitate communication and processing of information, documents, data, etc. Indeed, it is now rare to find a workflow in an enterprise that does not employ IT tools. The number of IT assets [such as software, computers, printers, scanners, multi-function devices (MFDs), other network-connected or standalone devices, etc.] is generally increasing and, as a result, managing and tracking IT expenditures is becoming a daunting task.

While the market for IT assets is expanding, the number of options when one looks for IT tools is also typically increasing. Accordingly, suppliers of IT tools generally find that they must offer competitive pricing and relevant information, on demand. Thus, even suppliers are commonly looking for improved tools that enable them to be competitive in the relevant market.

One approach for a vendor to make an educated and intriguing sales pitch to a customer or prospective customer is to present a proposal along with an analysis of the current IT expenditures of the customer or prospective customer. Thus, the vendor needs to be able to determine the current IT assets of the customer or prospective customer and then collate cost information regarding such assets. For example, costs can vary based on any of various aspects such as, but not limited to, acquisition type (i.e. lease/purchase), acquisition cost, depreciation of product, service cost, and in the case of printing products/services, consumables (e.g., paper, ink, toner, etc.) cost. Further, the vendor needs to be able to analyze the needs of the customer or prospective customer in order to be able to offer a package of products and/or services that is attractive to the customer or prospective customer.

The aforementioned analysis may be difficult to perform, by the vendor as well as by the customer or prospective customer, particularly when the customer or prospective customer is, or is a part of, a multi-national enterprise (i.e. having facilities at multiple sites and in multiple countries).

There exists a need for improved tools for determining, tracking and/or otherwise managing costs, expenditures, pricing, etc., in connection with information technology devices and other IT assets.

### SUMMARY

Various tools (e.g., systems, apparatuses, methodologies, computer program products, application software, etc.) can be provided to enable an analysis and/or overview of costs for an enterprise or another organization.

In an aspect of this disclosure, an enterprise analysis application (that is, one or more computer programs including instructions executable by a processor of a terminal) is provided to collect device data (including device cost or price data) for devices employed in the enterprise which includes plural sites. The enterprise analysis application can be configured to include a device data module to maintain plural device price tables to register the collected device price data. Such plural device price tables express the collected device price data in plural currencies. Further, the device price table may be configured to indicate device configuration corresponding to a device model, and indicate prices of device options, device accessory and/or device consumables. Thus, the enterprise analysis application can perform an enterprise analysis based on data retrieved from the device price tables, and output an enterprise analysis report reflecting the enterprise analysis. Such enterprise analysis enables a comparison between the cost of devices within the enterprise and devices available on the market which may be introduced into the fleet of IT assets employed by the enterprise.

The device price table may be currency-based. For example, the device price data registered by the device data module in a device price table may be limited to a single currency associated with that table. That is, device price data for a device model may be reflected in multiple device price tables in the respective currencies corresponding to the tables.

As another example, the application user interface may be configured to output price data to a user of the application user interface in a single currency associated with the user. That is, the application may associate the user (such as based on location, organization, user date, etc.) with a corresponding currency and/or corresponding device price table (and thus price data output to the user is obtained from the particular device price table to which the user is associated).

In another aspect, the application user interface may register data associating each organization with a corresponding currency and associating the organization with one or more of the device price tables, and register data associating a user with an organization amongst the registered organizations. In addition or alternatively, the application user interface may register data associating each organization with one or more of the device price tables to which users associated with the organization have access.

In another aspect of this disclosure, the enterprise analysis application may be adapted for an enterprise including plural sites disposed over plural countries. In such instance, the device data module maintains plural device price tables to register the collected device price data, and the plural device price tables express the collected device price data in plural currencies corresponding to the plural countries. Further, a site analysis table associates each site with a corresponding device price table and a corresponding currency and indicates a conversion rate to convert prices in the device price table associated with the site to a currency associated with the enterprise (that is, an enterprise analysis may be associated with a predetermined or selected currency). An analysis module retrieves the device price data in the plural device price tables, performs an enterprise analysis based on the retrieved device price data, and outputs an enterprise analysis report reflecting the enterprise analysis.

In another aspect, the analysis module may be configured to generate and output, for each site, a site analysis report, and the site analysis report for a specified site shows prices in the currency associated by the site analysis table with the site.

In another aspect, in a case that the retrieved device price data for a particular site is in a local currency different than the currency associated with the enterprise, the analysis module can convert the device price data in the local currency to price data in the currency associated with the enterprise by employing the conversion rate registered for the particular site in the site analysis table.

In another aspect, a method for performing an enterprise analysis of devices in an enterprise may include one or more of the following aspects:
(a) collecting device data, including device price data, for a plurality of devices employed in an enterprise including a plurality of sites, and maintaining plural device price tables to register the collected device price data in one or more storage devices, the plural device price tables expressing the collected device price data in plural currencies corresponding to the plural device price tables;
(b) retrieving the device price data in the plural device price tables, performing an enterprise analysis based on the retrieved device price data, and outputting an enterprise analysis report reflecting the enterprise analysis;
(c) registering organization data associating, for each particular organization amongst plural registered organizations, the particular organization with a corresponding currency and associating the particular organization with one or more of the device price tables;
(d) registering device table data associating each device price table with an associated currency amongst the plural currencies;
(e) maintaining an enterprise analysis table associating the enterprise with a specified currency, and maintaining a site analysis table which associates each site with a corresponding device price table and a corresponding currency and indicates a conversion rate to convert prices in the device price table associated with the site to the currency associated with the enterprise;
(f) in a case that the retrieved device price data for a particular site is in a local currency different than the currency associated with the enterprise, converting the device price data in the local currency to price data in the currency associated with the enterprise by employing the conversion rate registered for the particular site in the site analysis table;
(g) registering organization data associating a particular organization with one or more of the device price tables to which users associated with the particular organization have access.

### BRIEF DESCRIPTION OF THE DRAWINGS

The aforementioned and other aspects, features and advantages can be more readily understood from the following detailed description with reference to the accompanying drawings wherein:

FIG. 1A shows a block diagram of an enterprise analysis application provided to or on a terminal, in accordance with an exemplary embodiment;

FIG. 1B shows a block diagram illustrating a system for performing an enterprise analysis, for an enterprise or another organization, in accordance with another exemplary embodiment;

FIG. 1C shows a block diagram illustrating a system for performing an enterprise analysis, for an enterprise or another organization, in accordance with another exemplary embodiment;

FIG. 1D shows a block diagram illustrating a system for performing an enterprise analysis, for an enterprise or another organization, in accordance with another exemplary embodiment;

FIG. 2A shows a block diagram of an exemplary configuration of a terminal apparatus;

FIG. 2B shows a block diagram of an exemplary configuration of a computing device;

FIG. 3 shows a schematic diagram illustrating an example of flow of communication in the system shown in FIG. 1C;

FIG. 4 shows a flow chart illustrating a method performed by enterprise analysis application 101 in the system shown in FIG. 1A or terminal 103 in the system shown in any of FIGS. 1B-1D, in accordance with an exemplary embodiment;

FIG. 5 shows an example of user data table and enterprise data table;

FIG. 6 shows an example of a user interface display screen provided by the enterprise analysis application shown in FIG. 1A and/or on a terminal in the system shown in FIG. 1B, FIG. 1C or FIG. 1D;

FIG. 7 shows an example of a user interface display screen provided by the enterprise analysis application shown in FIG. 1A and/or on a terminal in the system shown in FIG. 1B, FIG. 1C or FIG. 1D;

FIG. 8 shows an example of a user interface display screen provided by the enterprise analysis application shown in FIG. 1A and/or on a terminal in the system shown in FIG. 1B, FIG. 1C or FIG. 1D;

FIG. 9 shows an example of a user interface display screen provided by the enterprise analysis application shown in FIG. 1A and/or on a terminal in the system shown in FIG. 1B, FIG. 1C or FIG. 1D;

FIG. 10 shows an example of a user interface display screen provided by the enterprise analysis application shown in FIG. 1A and/or on a terminal in the system shown in FIG. 1B, FIG. 1C or FIG. 1D;

FIG. 11 shows an example of a user interface display screen provided by the enterprise analysis application shown in FIG. 1A and/or on a terminal in the system shown in FIG. 1B, FIG. 1C or FIG. 1D;

FIG. 12 shows an example of a user interface display screen provided by the enterprise analysis application shown in FIG. 1A and/or on a terminal in the system shown in FIG. 1B, FIG. 1C or FIG. 1D;

FIG. 13 shows an example of device data tables;

FIG. 14 shows an example of a user interface display screen provided by the enterprise analysis application shown in FIG. 1A and/or on a terminal in the system shown in FIG. 1B, FIG. 1C or FIG. 1D;

FIG. 15 shows an example of a user interface display screen provided by the enterprise analysis application shown in FIG. 1A and/or on a terminal in the system shown in FIG. 1B, FIG. 1C or FIG. 1D;

FIG. 16 shows an example of a user interface display screen provided by the enterprise analysis application shown in FIG. 1A and/or on a terminal in the system shown in FIG. 1B, FIG. 1C or FIG. 1D;

FIG. 17 shows an example of an enterprise analysis report;

FIG. 18 shows a graphical representation of another example of an enterprise analysis system, in accordance with another exemplary embodiment; and

FIG. 19 shows a schematic representation of a structure for an enterprise analysis, in accordance with another exemplary embodiment.

### DETAILED DESCRIPTION

This patent specification describes tools (in the form of methods, apparatuses, systems, computer program products, application software, etc.) for performing an enterprise analysis and/or a site analysis of information technology (IT) provisions and/or costs, for an enterprise or another organization. Such tools may be useful to an information technology (IT) administrator or manager, and/or another person who has responsibility for purchasing IT tools and/or tracking or managing IT costs, for an enterprise.

On the other hand, such tools may also be configured to be useful to sales and marketing personnel for a supplier of IT equipment, devices, tools, etc. In order for a salesperson to make a sales pitch that would be attractive to a customer or prospective customer, the salesperson would prefer to have at their disposal the relevant information for establishing competitive pricing. Pricing can vary based on any of various factors, such as, but not limited to, acquisition type (i.e. lease/purchase), acquisition cost, depreciation of product costs, and in the case of printing products/services, costs of consumables (e.g., paper, ink, toner, etc.).

The tools can be configured to employ a combination of device data compiled from data obtained from one or more (third party or internal) databases, data entered by a user, or data derived from user-entered data or data obtained from another source. That is, in many instances, the volume of relevant data (e.g., device specifications, product options and consumables, price and cost data, etc.) requires large amounts of time and effort, if to be entered by a user. On the other hand, third party data is typically not complete and is supplemented by additional data entry and processing. For example, the typical third party database is based on data collected in a single country (e.g., the United States) and does not consider the circumstance that the target audience is multi-national.

In describing exemplary embodiments illustrated in the drawings, specific terminology is employed for the sake of clarity. However, the subject matter of this patent specification is not intended to be limited to the specific terminology so selected and it is to be understood that each specific element includes all technical equivalents that operate in a similar manner.

The drawings show examples of implementations of the subject matter of this patent disclosure in several computing environments. However, it should be understood that the subject matter of this disclosure can be utilized by any computing device including but not limited to PDAs, cell phones, personal, notebook and workstation computers, kiosks, other information terminals, etc. In addition, the subject matter of this disclosure might be provided as services in a modular fashion by other devices connected by a communication network.

Referring now to the drawings, wherein like reference numerals designate identical or corresponding parts throughout the several views, there is described tools (systems, apparatuses, methodologies, computer program products, etc.) for gathering and analyzing enterprise data based on the parameters set by the user.

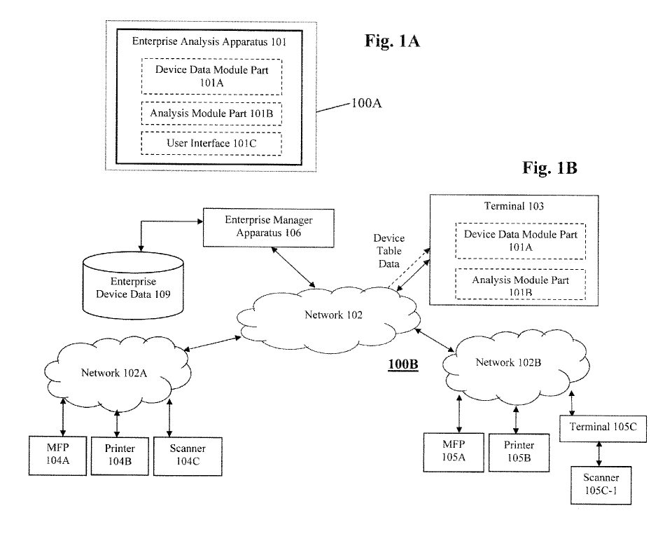

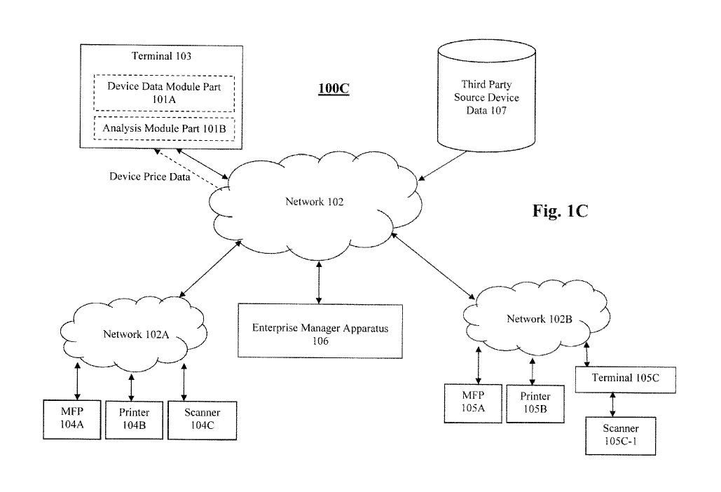

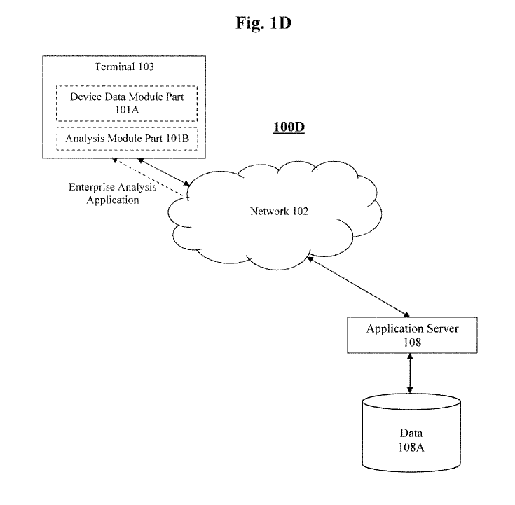

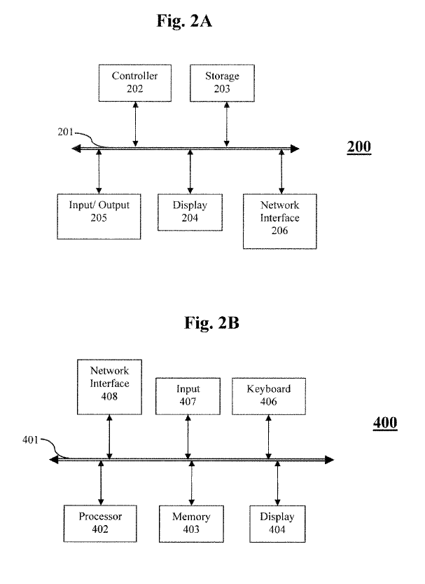

FIG. 1A shows a terminal apparatus 100A configured by an enterprise analysis application 101 to include a device data module 101A and an analysis module 101B. The terminal apparatus 100A can be implemented on any device including a processor, storage and display, such as, but not limited to, a smartphone, a handset, a tablet, other information terminals, etc., for example, having a configuration such as shown in FIG. 2A.

The device data module 101A is configured to register and store device data for various IT devices that may be employed in an enterprise, such as, but not limited to, printers, scanners, fax machines etc. The device information includes device information, such as, for example, standard retail price (SRP), color capabilities, speed, duplex printing etc., such as shown in FIG. 13. The information depicted in FIG. 13 is merely exemplary, and a wide range of other information may be included in the device information. Although the device information may be stored natively on the host device, one well versed in the art would appreciate that this information is also stored on third party servers for the most up-to-date information regarding printing systems and other office supplies, and the terminal apparatus 100A may be able to access these third party servers such as shown in the configuration of FIG. 1C.

The analysis module 101B is configured to format (or reformat) data retrieved from storage or received from another source, in order to portray enterprise analysis. Importantly, as discussed in more detail infra, the enterprise analysis application allows the user to define the parameters based on which to analyze enterprise expenditures. The analysis module 101B retrieves the information regarding said parameters from the device data module 101A and formats them into graphs, tables, etc. in order to visually show the expenditures of an enterprise. The parameters of these graphs may be changed at any point and, in addition, may be further broken down in order to analyze specific aspects of expenditures including, but not limited to, office and device.

The user interface 101C is generated by the apparatus for the ease of use for the salesperson or enterprise employee. As shown by way of example in FIGS. 6-12 and 14-16, the enterprise analysis application may provide the user with information and/or with access to tools that output enterprise and device information, in a format that is easy to comprehend for the user.

The terminal apparatus 100A may be configuration by an application, or another software component (such as part of the operating system or a device driver), of a terminal device. Such terminal preferably is configured to communicate through a data network to obtain content and data from an external source. However, it should be appreciated that the inventive aspects described herein can be employed even if the device is not configured to connect to such data network, and/or is not connected to the data network.

FIG. 1B shows a system 100B which includes a multi-function peripheral (MFP) 104A, a printer 104B and a scanner 104C, all of which are interconnected by a network 102A (“Network A”); an MFP 105A, a printer 105B and a terminal 105C connected to a scanner 105C-1, all of which are interconnected by a network 102B (“Network B”). Each of the networks 102A and 102B may be an intranet and they are connected by network 102 which may be an intranet and/or an internet (or extranet). Further, an enterprise manager apparatus 106 (including enterprise device database 109 connected thereto) and a terminal 103 are connected to the network 102.

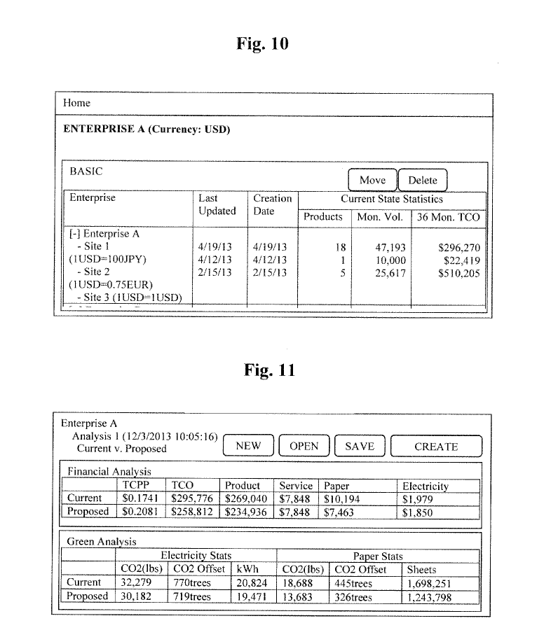

System 100C shown in FIG. 10 includes an MFP 104A, a printer 104B and a scanner 104C, all of which are interconnected by a network 102A (“Network A”); an MFP 105A, a printer 1055 and a terminal 105C connected to a scanner 105C-1, all of which are interconnected by a network 102B (“Network B”). Each of the intranets 102A and 102B is connected to the network 102. Further, each of enterprise manager apparatus 106, third party data source or server 107 and terminal 103 is connected to the network 102.

As an example, each of the Networks A and B respectively connected by the intranets 102A and 102B may represent a regional office of a global/national enterprise having multiple regional offices.

FIG. 1D shows schematically another example. In system 100D shown in FIG. 1D, each of application server 104 and terminal 103 is connected to the network 102.

It should be appreciated that the network environment, in any of the examples of FIG. 1B, FIG. 1C and FIG. 1D, can have an arbitrary number of devices (of various type).

The network 102 (as well as each of networks 102A and 102B) can be any data network, a local area network, a wide area network or any type of network such as an intranet, an extranet (for example, to provide controlled access to external users, for example through the Internet), a private or public cloud network, the Internet, etc., or a combination thereof. Further, other communications links (such as a virtual private network, a wireless link, etc.) may be used as well for the network 102. In addition, the network 102 preferably uses TCP/IP (Transmission Control Protocol/Internet Protocol), but other protocols such as SNMP (Simple Network Management Protocol) and HTTP (Hypertext Transfer Protocol) can also be used. How devices can connect to and communicate over networks is well-known in the art and is discussed for example, in “How Networks Work”, by Frank J. Derfler, Jr. and Les Freed (Que Corporation 2000) and “How Computers Work”, by Ron White, (Que Corporation 1999), the entire contents of each of which are incorporated herein by reference.

The MFP 104A, 105A, the printer 104B, 105B, the scanner 104C, 105C-1 can be any device having a primary functionality of printing copying, scanning, fax, etc. without providing additional functionalities.

The enterprise manager apparatus can be any of the various device management tools (such as application software, etc.) that are available to IT administrators to assist the administrators to track, monitor and otherwise manage IT (information technology) devices connected to a network. Such device management tools retrieve device settings or other device information from the devices, or other device data sources, through a network, and register such device information and allow the IT administrators to manage the devices. Thus, in the example of FIG. 1B and FIG. 1C, the terminal 103 can obtain device information for devices MFP 104A, 105A, the printer 104B, 105B, the scanner 1046, 105C-1 from the enterprise manager apparatus 106 through the network 102, and retrieve device information from the devices that are connected to Network A and Network B.

The third party server 107 can be configured to communicate with terminal 103, through the network 102, to provide an up-to-date register of device pricing and specification for office devices, such as the devices MFP 104A, 105A, the printer 104B, 105B, the scanner 104C, 105C-1, shown in FIG. 1B and FIG. 1C, respectively.

Application server 108 can be configured to communicate with terminal 103, through the network 102, to provide an application (such as an enterprise analysis application or apparatus) to the terminal 103 (or another device connected to the network 102), on demand.

The application server 108 can be configured as shown by way of example in FIG. 2B. Operations and configurations of application servers are well-known in the art and therefore, in the interest of brevity (and so as not to obscure the inventive aspects described herein), are not discussed at length herein.

An example of a configuration of a user terminal (e.g., the terminal 103) is shown schematically in FIG. 2A. In the example of FIG. 2A, terminal device 200 includes a controller (or processor) 202 that communicates with a number of other components, including storage 203, display 204, input/output (such as mouse, touchpad, stylus, microphone and/or speaker with voice/speech interface and/or recognition software, etc.) 205 and a network interface 206, by way of an internal bus 201.

The storage 203 can provide storage for program and data, and may include a combination of assorted conventional storage devices such as buffers, registers and memories [for example, read-only memory (ROM), programmable ROM (PROM), erasable PROM (EPROM), electrically erasable PROM (EEPROM), static random access memory (SRAM), dynamic random access memory (DRAM), non-volatile random access memory (NOVRAM), etc].

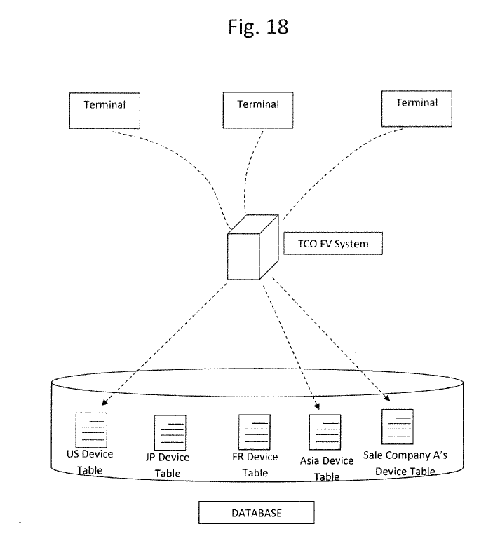

The network interface 206 provides a connection (for example, by way of an Ethernet connection or other network connection which supports any desired network protocol such as, but not limited to TCP/IP, IPX, IPX/SPX, or NetBEUI) to a network (e.g., network 102) to enable the terminal device to communicate with another device through the network. FIG. 2B shows an exemplary constitution of a computer 400 which can be configured by appropriate programming to operate as the enterprise manager apparatus 106 (FIG. 1B, 1C), as the third party server 107 (FIG. 1C) or as the application server 104 (FIG. 1D). The computer 400 shown in FIG. 2B includes a processor 402, and various elements connected to the processor 402 by an internal bus 401, such as a network interface 408, memory 403 and display 404. The processor 402 processes incoming requests transmitted through the network interface 408. The network interface 403 enables the application server 400 to communicate with other network-connected devices such as a terminal (e.g., the terminal 103 of FIG. 18, FIG. 1C or FIG. 1D) and receive data or service requests.

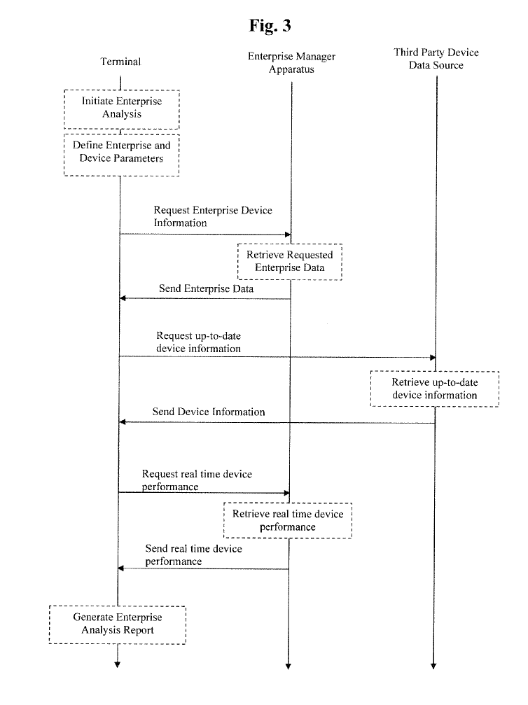

Each of the terminal 103, enterprise manager apparatus 106 and third party server 107 is configured to communicate with each other through the network 102. Through the network, the terminal 103 requests enterprise device information from the enterprise manager apparatus, as shown by way of example in FIG. 3. When the terminal initiates an enterprise analysis and defines the enterprise and device parameters, it may need information regarding the devices within an enterprise from the enterprise manager apparatus 106.

Information retrieved from the third party server 107 may include, but not limited to, pricing, hardware costs, service costs, consumable costs, other costs, usage costs, hardware and supplies pricing, printer yields, and service pricing. Pricing may refer to pricing of devices based on different parameters, including, retail costs, manufacturer suggested retail price and/or rebates. Hardware costs depend on monthly maintenance of hardware analysis based on a specific amount of time. Service costs refer to costs that are included in warrantee service and time period, extended warrantee service and may also include toner inclusive service in the case of printing products. Consumable costs calculate price of consumables based on the yield of a device. Other costs refers to costs relating to inefficiencies of a product (i.e. finishing, duplex, etc.). Usage costs calculates costs by proportionately increasing/decreasing volume of use over all devices, wherein the time frame may be adjusted to calculate cost. Hardware and supplies pricing collects printer hardware and street pricing from main internet vendors. Printer yields collects consumable yield information direct from each manufacturer at time of device introduction. Service pricing is represented as a manufacturer-branded extended warranty pack in increments of 1 to 5 years.

Additional information supplied by the third party server 107 may include energy impact, typical electricity consumption (TEC), CO2 emission, paper impact and CO2 offset. Energy impact calculates the energy consumption of devices based on data published the Environmental Protection Agency. TEC value is derived from measuring each model's electricity consumption in a lab that is setup to represent the “average office” environment and thus does not reflect actual electricity consumption, however, provides a valuable and consistent method of measuring equipment energy consumption performance. CO2 emission is calculated from the TEC of the device based on average carbon emissions for electricity generation. Paper impact refers to the production and distribution of paper that in turn produces carbon emission. CO2 offset refers to the amount of trees that can absorb carbon emissions from electricity and paper consumption.

Additionally, the terminal 103 may wish to receive up-to-date information regarding the enterprise devices to provide accurate enterprise analysis. That is, if the information stored within the terminal 103 is outdated, then the terminal 103 may refresh this data. Also, many printing devices offer progress reports on their status and condition. That is, the printer may send a report describing its degradation, if any, status, malfunctions, efficiency etc. The terminal 103 requests the real-time device information from the enterprise manager apparatus 106 to provide an additional parameter to generate an enterprise analysis report.

Up-to-date information received from the enterprise manager apparatus 106 may supplement and/or substitute the information retrieved from the third party server 107. For example, the third party server 107 may not contain necessary information regarding the devices being analyzed for an enterprise analysis. Therefore, the enterprise analysis application 101 may send a price table template to the enterprise manager apparatus 106. The enterprise manager apparatus 106 then fill outs the information in the template. This information may include, but not limited to, price, maintenance, costs, etc. of the device models being used in that enterprise. This information can be stored in a database (such as 109 depicted in FIG. 13, or 107 depicted in FIG. 1C or depicted in FIG. 1D) of a server, and may be accessed by any user to update information regarding certain device models for cost analysis.

These price tables may be prepared by different enterprises within different regions and countries, using different currencies. This information may then be accessed by any user utilizing the enterprise analysis application 101, regardless of default region or currency associated with the user.

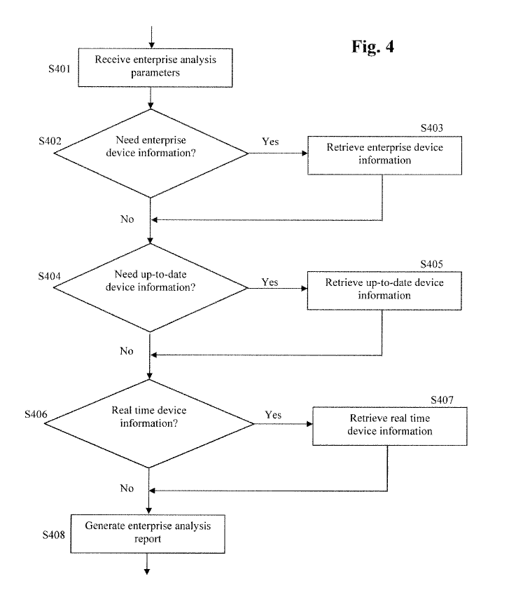

A process by which the enterprise analysis application 101 collects and formats data to generate an enterprise analysis report is discussed infra with reference to FIG. 4. First, a request with selected parameters for an enterprise analysis is received (S401). With these given parameters, the enterprise analysis apparatus 101 determines whether it is necessary to request enterprise device information (S402) and if so (S402, Yes), retrieve the enterprise device information (S403) from the enterprise manager apparatus. The enterprise manager apparatus retrieves the device from all the devices directly connected to the network, as well as devices connected solely to terminals on the network. For example, the enterprise manager apparatus in FIG. 1B may collect data from the scanner 105C-1 even though the scanner 105C-1 is only connected to the network through terminal 105C.

The enterprise analysis apparatus 101 determines (in S404) based on the given parameters whether it is necessary to request up-to-date device information from the third party server 107. If so (S404. Yes), the enterprise analysis apparatus 101 retrieves such data (S405). The enterprise analysis apparatus 101 may also employ real-time device information in the cost analysis of an enterprise. The enterprise analysis determines whether real-time device information is available (S406) and if so (S406, Yes) retrieves the real-time device information from the enterprise manager apparatus 106 (S407).

Based on the given parameters set by the user, the enterprise analysis apparatus 101 generates an enterprise analysis report (S409). As discussed infra, the enterprise analysis report may be output as, but not limited to, a PDF file, Excel worksheet, Word document, etc.

The steps S402, S404 and S406, in FIG. 4, may all be interchanged and are not dependant on order. In addition, one can see that the enterprise analysis apparatus 101 does not need to retrieve any information from either the third party server 107 or the enterprise manager apparatus 106. That is, the enterprise analysis apparatus 101 may generate an enterprise analysis report based on information stored in the storage 203. For example, a person may use the enterprise analysis apparatus to hypothesis cost based on an imaginary enterprise a custom set of office devices. Therefore, no information would pertain to a hypothesized enterprise and/or office device. However, it should be appreciated that this hypothetical layout is just an example and creating custom devices and enterprises may still be a powerful tool when managing and/or planning an enterprise.

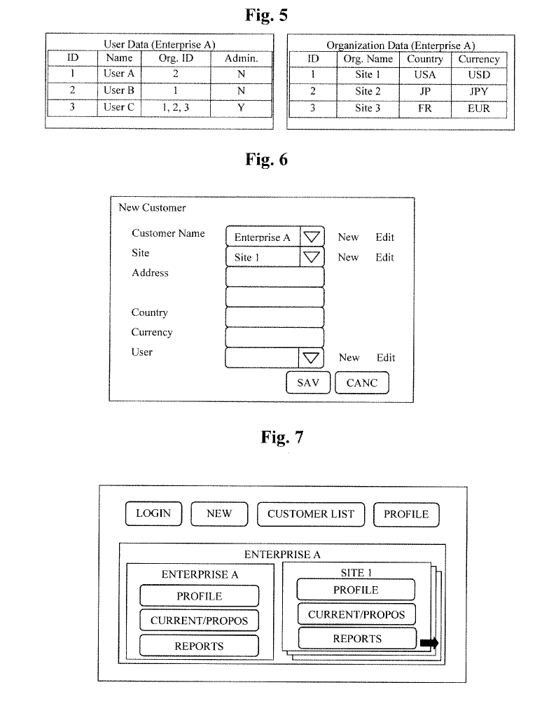

FIG. 5 shows data tables including information regarding user data and organization data. The user data represents the type of access each user, within a certain enterprise, is provided. For example (FIG. 5), User A has access to organization ID number 2, while User C has access to organization ID number 1, 2 and 3. It is preferable to give certain user certain types of limited access for the sake of security of an enterprise. In addition to each user being associated with specific sites, each user may be associated with the currencies of those respective sites. That is, when a user logs in and is provided access to the information of an enterprise or site, the expenditure and price analysis is performed based on the currency associated with the user or enterprise. This embodiment is not limited to a simple currency conversion of existing prices. That is, prices for certain products and/or regions may differ from region to region, and therefore the cost analysis of an enterprise and/or site may be based on local prices.

In addition to access to specific organizations, the user may be limited to specific device tables and prices corresponding to the region with which the user is associated. For example, a user in Europe may be limited to the device price tables (discussed infra in connection with FIG. 13) corresponding to the devices and prices available in that region. Depending on the access and privileges of the specific user, the enterprise analysis application may permit the user to access device price tables associated with other regions and other currencies.

In the table of FIG. 5, administration status of each user is specified. By being an administrator, a user has control over adding/deleting users and controlling the privileges of each user. That is, the administrator has control over the preferences and access of each user. For example, the administrator may choose to limit or extend the site information that a specific user has access to.

The organization data table is an example of information regarding sites within an enterprise. In the exemplary embodiment shown in FIG. 5, the organization data includes information regarding the sites associated with Enterprise A. Listed in the table is also the country in which the site is located, the currency in which the site pays its expenditures. In other embodiments (such as, for example, FIG. 11), an enterprise and its sites can be modeled using addition expenditure information such as, but not limited to, employee expenditure, monthly overall cost, CO2 emission cost, total cost per page (TCPP), product maintenance cost, paper cost, etc.

FIG. 6 is an exemplary embodiment of a user interface that can be used to add new customers and/or sites to a database, A user with administrative privileges may also edit information regarding existing enterprises and/or sites already registered in the database. For example, the enterprise analysis application may allow a user to change the default currency for an existing enterprise. Costs and prices employed in an enterprise analysis of the enterprise may be based on the default currency associated with the enterprise. In addition, a user with administrative privileges may choose to assign additional users to have access to information regarding a certain enterprise. Also, by giving a user access to a new enterprise, the enterprise analysis application may allow the user to access the device data tables (such as shown by way of example in FIG. 13) corresponding to the region in which the enterprise is based. For example, a user may only have access to the device data tables associated with region 1 because all of the enterprises for which the user may perform cost analysis are located in region 1. However, if the user is afforded additional privileges to obtain cost analysis of an enterprise in region 2, then the user may have access to device data tables associated with region 2.

An exemplary embodiment of a top-level user interface is shown in FIG. 7. Once user login is authenticated, the enterprise analysis application allows the user to access each of the user's profiles, containing the preferences associated with that profile. For example, the user interface may be changed into a different language based on the preferences of the user. In addition, the enterprise analysis application may allow the user to access reports of respective sites to which the user is associated. Further, the enterprise analysis application may allow the user to perform enterprise analysis or site analysis based on the default currency associated with the user and/or site.

The enterprise analysis application, through this UI (FIG. 7), allows the user to navigate available options of an enterprise analysis, customize the parameters of the analysis, recall previous analysis reports and create new analysis reports. The custom parameters may be made a default for the enterprise analysis of future enterprises. Each user may define their own default parameters based on their own needs for expenditure analysis.

As shown in the exemplary embodiment, enterprise A has options in which a user may generate reports, look at detailed analysis of the enterprise and propose new device layout of the enterprise and generate these reports into file types such as, but not limited to, Excel sheets, PDFS and Word documents, as discussed infra. A detailed analysis of an enterprise may include, but is not limited to, the device fleet of the enterprise, the cost of office supplies (e.g. paper, stationary, etc.), utility costs and CO2 emission cost. A device fleet analysis may include a list of all printing devices (e.g. printers, scanners, fax machines, MFP) listed with the cost of each device. In order to calculate the cost of each device, the enterprise analysis apparatus 101 may take into account the overall cost of the machine (e.g. SRP or street price), electricity cost in kWh, TCPP, CO2 emission cost and maintenance cost. The cost analysis is not limited to these parameters and may be customized by the user. For example, the enterprise analysis application may allow the user to choose a time period for which this cost analysis is made and calculated. With this option, the enterprise analysis application allows the user to analyze the performance of devices in an enterprise for a specific time frame. Also, by employing information or data of previous trends, the enterprise analysis application may allow the user to obtain an analysis report for the future cost of the devices. A cost report based on the given parameters may be generated by the enterprise analysis apparatus 101. The costs reports may be saved and later recalled.

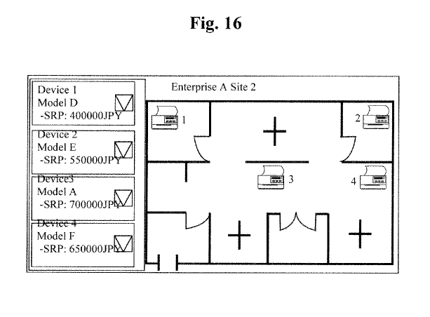

In addition to generating a detailed analysis of the enterprise, the enterprise analysis application may be configured to provide options focusing on individual sites within the enterprise. In this exemplary embodiment, enterprise A includes three sites, and previous or current analysis reports may be accessed through the user interface. The user may also generate reports for the expenditures and costs of each individual site in order to further analyze the expenditures of the enterprise as a whole. In addition, the enterprise analysis application may provide the user with a graphical view of the layout of a site, as shown in FIG. 16, to allow the user to identify particular devices.

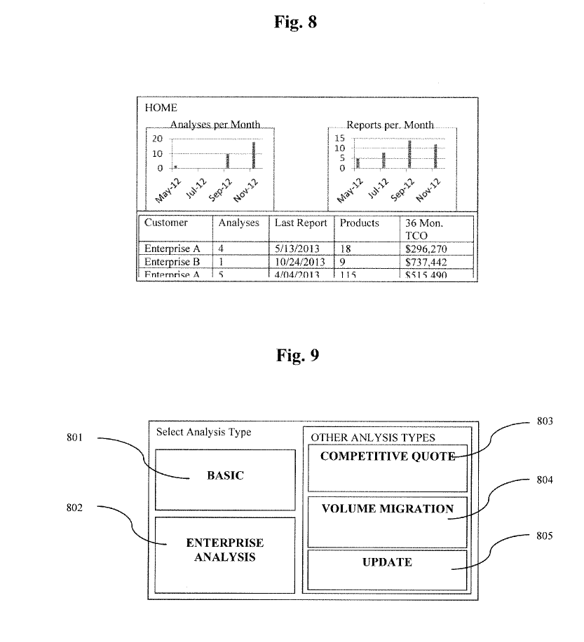

FIG. 8 is an exemplary embodiment of a user interface of the home page of the enterprise analysis apparatus 101. This UI gives general information frequency and regularity the enterprise analysis apparatus 101 has been used for enterprise cost analysis. Information on the home page may include, but not limited to, graphs showing the amount of analyses and reports per month as shown in the figure. In addition, the UI may include a list of the customers associated with the specific user, the amount of analyses done for each particular enterprise and other information that may contain the amount of products an enterprise has and/or a total cost of operation for a specific time period of the enterprise. This chart may be customized to include other information based on the user's preferences. The customer names display in the 1st column may also function as a link to go into the analysis list for the customer. In the Analysis list, described further in FIG. 11, the user can see previous analyses done in more detail.

FIG. 9 is an exemplary embodiment of a user interface which lists examples of the type of analysis that a user may choose for an enterprise or site. Basic analysis 801 refers to a quick analysis of an enterprise based on preset preferences. These preferences may even limit the analysis to solely take into account certain criteria such as expenditure of printing machines.

The basic analysis 801 provides a simple analysis to assess the current situation and generate a new proposal. The user can manually input and/or import data to the system, and the analysis is performed based on user preference. Such basic analysis may employ the default currency of the enterprise.

Enterprise analysis 802 maps and analyzes an enterprise using a collaborative analyst effort. That is, for example, the enterprise analysis apparatus 101 may retrieve all the additional information that may go into the analysis of an enterprise as previously described in FIG. 4. By performing a more extensive analysis, the enterprise analysis apparatus 101 can provide the most up-to-date and detailed analysis of an entire device fleet of an enterprise. The default currency for the enterprise analysis 802 may be the default currency of the selected enterprise. However, if the default currency of the specific logged-in user is a different currency than the default currency of the selected enterprise, the displayed currency in the cost analysis report may follow the specific logged-in user's default currency. The enterprise analysis application may allow prices in the cost analysis to be converted using a real-time exchange rate and/or an exchange rate specified by the user.

The enterprise analysis 802 provides a more detailed analysis compared to the basic analysis 801 by providing an Enterprise/Site Level analysis and a floor map, with examples depicted in FIGS. 16. An enterprise analysis 802 can have multiple site level analyses. In enterprise level analysis 802, users can see the summary of site level analyses which belong to the enterprise level analyses. In site level analyses, users can input product data, service cost, map, etc. for each site, as discussed infra. In addition, the enterprise analysis 802 can provide the user with information associated with each site and user roles.

Other options depicted in FIG. 8 include a comparison quote 803. The comparison quote 803 generates a hypothetical cost analysis of an enterprise or site with a proposed layout. A user may propose to change an existing device fleet of printing machines from one set of models to another. A user may propose more cost efficient printing machines based on the needs of the enterprise shown in analysis reports. For example, a cost analysis may show that an enterprise or site has not used any color printing capabilities within the last month. A proposal from a user might be to replace the color printing machine with that of a more cost efficient machine and/or a machine requiring less maintenance. In addition, a user may use this proposal to compare with a competitor's proposal for new products and cost efficient strategies and solutions.

Another analysis type depicted in the present embodiment is volume migration 804. Volume migration 704 analyzes the volume of printing done within an enterprise and moving that volume to specific printing devices. For example, during a month an enterprise may print over 1000 sheets to five separate devices. The volume migration 804 analysis may depict the costs if the printing of those 1000 sheets was limited to two devices. If printing is limited to efficient high-volume printing devices, the overall price per month on printing expenses may drop.

Another option depicted in the current embodiment is an update 805 of the current product fleet of an enterprise and/or site. Over time devices degrade and prices fluctuate. By providing updated information, the enterprise analysis application allows the user to see the cost of maintaining a product in its current state. Maintenance cost for an older product may increase more prominently over time, and therefore the enterprise analysis application may be configured to provide the user with the most up-to-date information regarding future expenditures. For example, as a product ages, the production for maintenance of said product may cease and therefore maintenance costs would rise. In addition, as a product ages it may no longer use ink/toner efficiently, therefore increasing the monthly cost of ink/toner.

FIG. 10 is an exemplary embodiment of a user interface mapping an enterprise and its existing sites. Each enterprise can be expanded to show the sites associated with each enterprise. In addition, cost analysis may be selected either for the enterprise or, by expanding site information, for each specific site.

Each site has information regarding its primary currency. In this embodiment, the primary currency of the enterprise is listed as USD, however as shown, the primary currency of the sites may vary. Also listed in this embodiment, is the exchange rate of currencies. This exchange rate may be a real-time exchange rate or a rate specified by the user.

The enterprise analysis application may allow the user to customize the user interface in order to have a clear overall visual mapping of an enterprise and its sites. Additional information displayed in this embodiment includes the last updated date of the analyses, creation date of the analyses and current state statistics of the enterprise. The enterprise analysis application may provide current state statistics to provide an overall view for the user as to the costs of each site. The current state statistics may include fields such as, but not limited to, the amount of products, monthly volume and total cost of operation per length of time.

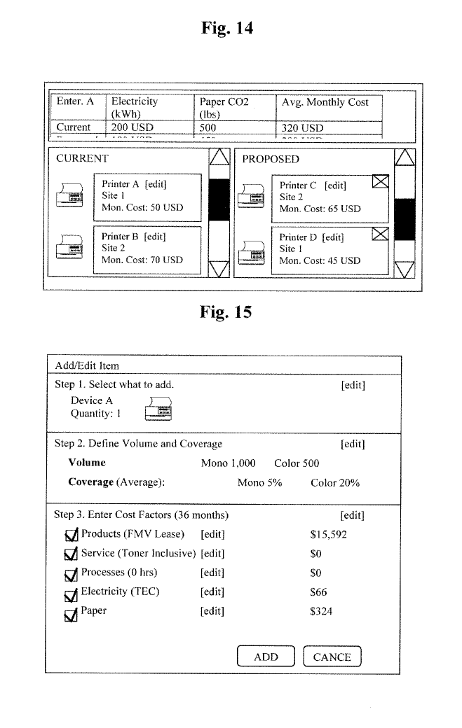

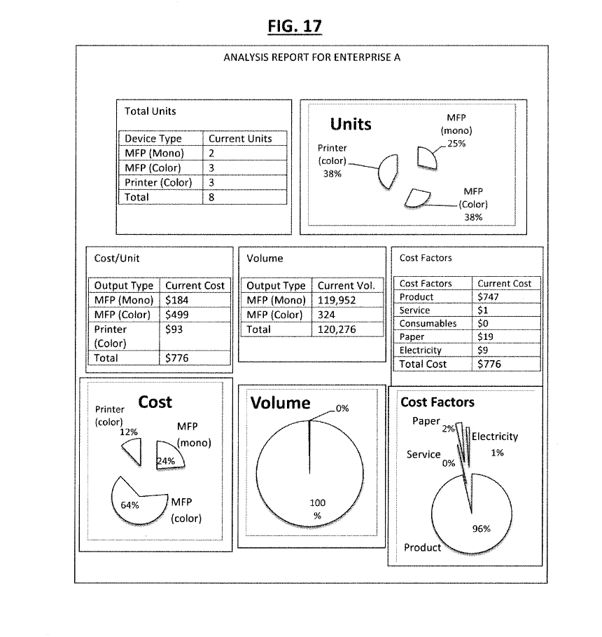

An exemplary embodiment of an outline of a comparable cost analysis UI is shown in FIG. 11. The cost analysis may be based on either the default currency of the user or the default currency of the enterprise on which the analyses are done. As shown in FIGS. 14 and 15, the analyses can be further broken down into particular products and solutions proposed by the user. In the current embodiment, the enterprise analysis application allows the user to save the current analyses, open and/or compare previous analyses with the current one and create a report of either the current analyses or comparison analysis, as shown in FIG. 17.

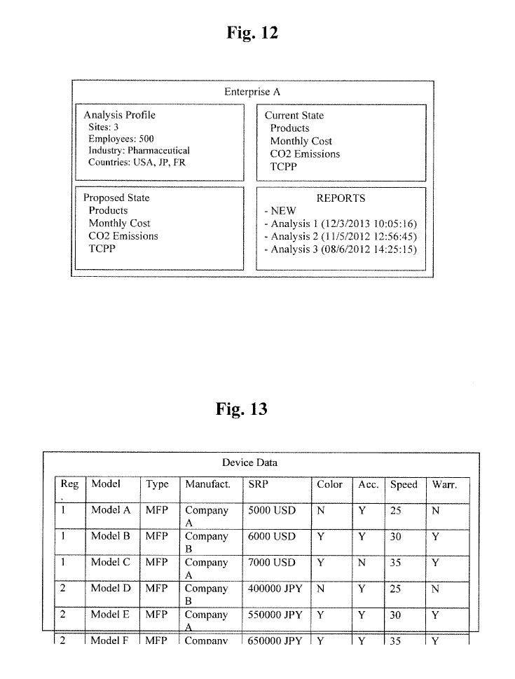

FIG. 12 is another exemplary embodiment showing information regarding an enterprise's costs. Through this UI, a user is able to see more information regarding an enterprise profile and have easy access to previous analyses made sorted by the date in which they were composed. Also, in this exemplary embodiment, the enterprise analysis application allows the user to see the current status of expenditures for an enterprise based on parameters set by the user and have a side-by-side comparison showing a proposed state from an enterprise and its corresponding costs. The user has easy access to site data as well. For a more detailed view, a user has the ability to generate and/or view reports for the current state, the proposed state or both side-by-side.

An exemplary embodiment of a device data table is shown in FIG. 13, wherein the each device is listed with its respective region. In this embodiment, each model is listed with its type, capabilities and SRP. The prices may be based on the price provided initially for the device, but may also be updated to include current prices for the same device, based on the current state of the market and region in which the site is located. In addition, each device has the manufacturer associated with the device. The price provided for each device may also depend on the MSRP provided by the manufacturer.

For a specific user, the device table may be limited to the region that the specific user is associated with. For example in the exemplary embodiment of FIG. 13, the enterprise analysis application may limit the user to the information associated with region 2 corresponding to JPY currency. However in the case that the user has privileges corresponding to multiple regions, the price for each device may be listed in the corresponding currency associated with the user and/or the currency associated with the enterprise which the user is performing analyses on. The calculation of the price, when going from one currency to another, may be based on a real time exchange rate or an exchange rate specified by the user and other factors.

For example, FIG. 13 shows model A as a device present in both region 1 and region 3. However, the SRPs for the two regions are different because of the different associated currencies for each site. This difference in price may be associated with the real-time (or user-associated) exchange rate for the currencies, and may also depend on the prices provided by the manufacturer and other factors that would cause price discrepancy such as, but not limited to, shipping prices, warrantees offered, accessories included, etc, which factors may be included in the device data table. Therefore, when doing a price analysis and discussing proposals, a user may take into account the fact that by providing new devices at lower cost, there may be a discrepancy in services required and that the prices do change based on location and currency.

FIG. 14 is an exemplary embodiment of a UI allowing a user to create and compare a device layout proposal with the current status of the enterprise. This UI can be also used to do individual site analysis. In FIG. 14, the enterprise analysis application allows the user to propose a device arrangement using available market devices from any region or manufacturer. The proposed costs are then tabulated along with the current costs. In the current embodiment, the enterprise analysis application may tabulates the prices in terms of the main currency for enterprise A, USD. If a user were performing a site analysis on the currency used would be either the currency associated with the user, currency associated with the enterprise and/or currency associated with the site being analyzed. The enterprise analysis apparatus 101 takes into account the region as well as the currency. For example, the prices of electricity vary greatly from region to region and are all tabulated and converted into a single currency, by the enterprises analysis application. Thus, when proposing a layout for a site or enterprise, the enterprises analysis application can provide up-to-date costs and accurately portray the actual cost when installing new devices. Other factors may contribute to a unique cost of a device between regions based on shipping of a device, taxes, device upkeep, etc. In addition, the currency exchange between regions may contribute to the cost. The currency exchange may be retrieved from a third party server or input by the user.

The factors that contribute to the price difference between regions as well as additional price factors may be edited by the user, as shown in FIG. 15. In the UI shown in FIG. 15, a user may select a device in order to propose a new cost analysis for an enterprise. All the devices available for cost analysis are taken from the device data table, as previously described in FIG. 13.

Once a user chooses a device to add to the enterprise analysis, the user may choose to edit the volume and cost factors to provide a more detailed cost analysis. For example, as shown in FIG. 15, the user may input a certain volume of printing done by an enterprise which may change the cost for printing services of a product. Then the user may choose services, options, accessories and/or device consumables to further customize the price of a device. In the exemplary embodiment shown in FIG. 15, the user has the option to highlight and add cost factors to the enterprise cost analysis. These cost factors include, but are not limited to, products, services, processes, electricity and paper. These costs may be retrieved from a third party server, an enterprise manager apparatus and/or input by the user.

Another exemplary embodiment of a UI used to propose new device layouts for an enterprise or site is shown in FIG. 16. In this exemplary embodiment, the UI includes a floor plan of the site in which a user may reorganize or introduce new machines to an office layout. All the prices for this embodiment are in JPY to further show that the currency is based on the enterprise currency. In the present embodiment, the enterprise is shown to be based in Japan with a default currency of JPY, therefore, the prices in this analysis are provided in the default currency. The enterprise analysis apparatus 101 may convert device price solely based on the currency exchange rate, however, it may also take into account the price that a manufacturer would offer to a specific region. That is, a manufacturer might charge a different price based on region and in order to have an accurate price proposal for devices within a site or enterprise, these parameters are taken into account.

This type of analysis allows the user to create maps easily in customer sites. The analysis integrates all the types of analysis, as discussed previously, including but not limited to, device pricing, maintenance costs, idle costs, stationary costs, etc.

FIG. 17 is an exemplary embodiment of an enterprise analysis report generated by the enterprise analysis apparatus 101. The statistics listed in the document may include, but are not limited to, total units with an enterprise, cost per unit, volume and cost factors. These parameters of the enterprise analysis report can be preset and/or customized by the user. In this embodiment, enterprise A is shown to have a total of 6 units, wherein the table separates the units based on MFP color, MFP mono and printer color. The next table shows the costs amounted by each unit type. In the current embodiment, MFP color printers amounted for the highest costs at 499 USD. The next table tabulates the volume of printing done by each type of device. As shown in FIG. 17, the highest volume of printing is performed by the MFP mono devices. In this particular embodiment, a user might realize a discrepancy between the cost of unit upkeep vs. the volume and decide to change the concentration of MFP color devices within an enterprise.

The enterprise analysis report may be formed in additional formats such as, but not limited to, PDF, Excel worksheet and/or Word document. For example, raw data in table form might be constructed from the raw data, however, for the sake of visualization the current embodiment includes graphs and tables.

Another example in which the enterprise is a multi-national organization having facilities at plural sites disposed over plural countries will now be discussed. The tools described herein can be particularly useful in the circumstance that available device models and their configurations, options and prices are different in various regions, countries and sales companies. Further, even if some models are commonly available in different countries, the price and configuration maybe different.

In such example, a tool (referenced herein as “TCO FV”) may be configured to include the features described herein to perform an analysis for such a global enterprise (e.g., user's customer or employer) which has many branches or sites all over the world, in which each branch or site has local device models and currency, and have the analysis show a summary of all branches or sites with one currency.

In such example of a multi-national organization, device price table data for each region, country or sales company may be obtained and registered (e.g., FIG. 18) and utilized in the analysis. The following Table 1 (device price data) and Table 2 (device table data) are an example of a structure for capturing device price data. Each device price data record in Table 1 has a Table ID (e.g., record ID 5 for “imagio C3000” is associated with Table ID 2, i.e. Ricoh Japan Devices) which identifies the table from which data was obtained for the record, and in Table 2, the Table ID is associated with an organization (Org ID) with which the data is associated, a Table Name and a currency (e.g., Table ID 2 is associated with Ricoh Japan Devices and JPY, i.e. Japanese yen) Such approach allows the tool to accept more new device table data and device price data,

TABLE 1

| | | | | | | | | | | | | | Toner |
|---|---|---|---|---|---|---|---|---|---|---|---|---|---|
| | Table | | | Product | | | St. | | | | Ext. | Toner | St. |
| ID | ID | Model Name | Vendor | Type | Part No. | SRP | Price | Color | Speed | Duplex | Tray | SRP | Price |
| 1 | 1 | Aficio MP | Ricoh | MFP | 4132100 | 5,000 | 4,000 | No | 25 | No | Yes | 120 | 100 |
| | | 2500 | | | | | | | | | | | |
| 2 | 1 | Aficio MPC | Ricoh | MFP | 4133000 | 6,000 | 5,000 | Yes | 30 | Yes | Yes | 150 | 120 |
| | | 3000 | | | | | | | | | | | |
| 3 | 1 | Aficio MPC | Ricoh | MFP | 4133001 | 7,000 | 6,000 | Yes | 35 | Yes | Yes | 150 | 120 |
| | | 3500 | | | | | | | | | | | |
| 4 | 2 | imagio 2500 | Ricoh | MFP | 4132100 | 400,000 | 350,000 | No | 25 | No | Yes | 120 | 100 |
| 5 | 2 | imagio C3000 | Ricoh | MFP | 4133000 | 550,000 | 400,000 | Yes | 30 | Yes | Yes | 150 | 120 |
| 6 | 2 | imagio C3500 | Ricoh | MFP | 4133001 | 650,000 | 500,000 | Yes | 35 | Yes | Yes | 150 | 120 |
| 7 | 3 | Aficio MP | Ricoh | MFP | 4132100 | 4,500 | 3,500 | No | 25 | No | Yes | 120 | 100 |
| | | 2500 | | | | | | | | | | | |
| 8 | 3 | Aficio MPC | Ricoh | MFP | 4133000 | 5,000 | 4,000 | Yes | 30 | Yes | Yes | 150 | 120 |
| | | 3000 | | | | | | | | | | | |
| 9 | 3 | Aficio MPC | Ricoh | MFP | 4133001 | 6,500 | 5,500 | Yes | 35 | Yes | Yes | 150 | 120 |
| | | 3500 | | | | | | | | | | | |

Table Error! No text of specified style in document.

| Table ID | Org ID | Table Name | Currency |
|---|---|---|---|
| 1 | 1 | Ricoh US Device Table | USD |
| 2 | 2 | Ricoh Japan Devices | JPY |
| 3 | 3 | Ricoh French Table | EUR |

The device price data can be, as discussed above, compiled from data obtained from one or more (third party or internal) databases, data entered by a user, or data derived from user-entered data or data obtained from another source. In this example, all of the devices shown in Table 1 were obtained from a vendor “Ricoh”, and the device price data may have been provided by Ricoh's sales company, Ricoh's regional head quarter, and/or a third party database. Such data may be imported into the system manually, or programmatically with periodic updates.

The system may automatically determine a device price table to be used for a user based on login credentials. If the device price data displayed through the user interface employs a mix of currencies, or employs a currency that is other than the currency that the user normally uses, the user may sometimes be confused (or at least be inconvenienced). For example, if a user is Japanese, it can be very confusing to that user if the device price data is represented in dollars, euros or francs.

Thus, the following Table 3 (user data), Table 4 (organization data) and Table 5 (device table data) are an example of a structure for capturing the relationship between users, organizations and device tables.

TABLE 3

| User ID | Name | Password | Org ID |
|---|---|---|---|
| 1 | Kenji Hagiwara | xxxxxxx | 2 |
| 2 | Tim Brown | xxxxxxx | 1 |
| 3 | David Smith | xxxxxxx | 1 |

TABLE 4

| Org ID | Org Name | Country | Currency |
|---|---|---|---|
| 1 | Ricoh US | USA | USD |
| 2 | Ricoh Japan | Japan | JPY |
| 3 | Ricoh France | France | EUR |

TABLE 5

| Device | | | |
|---|---|---|---|
| Table ID | Org ID | Table Name | Currency |
| 1 | 1 | Ricoh US Device Table | USD |
| 2 | 2 | Ricoh Japan Devices | JPY |
| 3 | 3 | Ricoh French Table | EUR |

When a user logins to the system, the system determines based on Table 3 the user's organization and by using the organization ID (Org ID) to cross reference Table 5, determines the device table that is appropriate for the user (e.g., Kenji Hagiwara is associated with Org ID 2, and with Ricoh Japan Devices). In such example, the user may be limited to access to the devices and data from the device table associated with the organization to which the user is associated.

In this example of a multi-national organization, the user also has the option of performing an enterprise analysis and multiple site analyses in connection with the enterprise analysis. In an enterprise analysis, an enterprise analysis report may be generated as a summary of the analyses of all sites registered with the enterprise. On the other hand, in a site analysis, device information for devices employed at the site is summarized in a site analysis report for the site.

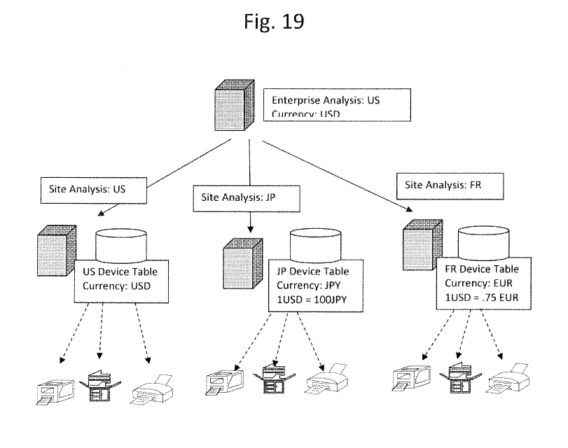

In such analyses, and more specifically, in an enterprise analysis for a multi-national enterprise, each site is associated with a currency and may be associated with different device models, as shown schematically in FIG. 19. In the example shown in FIG. 19, the enterprise analysis is set to be performed with USD (dollars) as the currency associated with the enterprise and three site analyses, based on with US Device Table, JP Device Table and FR Device Table, are performed. In each site, the user can register devices from the device table associated with the site. Thus, the user can view data and reports with USD in the enterprise analysis, and the user can view the Japan site analysis with JPY (Japanese yen).

On the other hand, Japan site analysis (in JPY) and France site analysis (in EUR, i.e. euros) have different currencies from the enterprise analysis (in USD). In order to conduct the analyses and generate reports with USD, the system is configured to include a currency converter between USD and JPY, USD and EUR, and even optionally between JPY and EUR (to allow enterprise analysis in JPY or EUR). For example, the following Table 6 (enterprise analysis data), Table 7 (site analysis data) and Table 8 (device table data) represent an example of a structure that may be employed.

TABLE 1

| ID | Enterprise Analysis Name | Currency |
|---|---|---|
| 1 | Ricoh Global Analysis | USD |
| 2 | Microsoft | USD |
| 3 | Toyota | JPY |

TABLE 2

| | | Site Analysis | | |
|---|---|---|---|---|
| ID | Enterprise ID | Name | Device Table ID | Exchange Rate |
| 1 | 1 | Ricoh US Site | 1 | 1 |
| 2 | 1 | Ricoh JP Site | 2 | 100 |
| 3 | 1 | Ricoh FR Site | 3 | 0.75 |

TABLE 3

| ID | Org ID | Table Name | Currency |
|---|---|---|---|
| 1 | 1 | Ricoh US Device Table | USD |
| 2 | 2 | Ricoh Japan Devices | JPY |
| 3 | 3 | Ricoh French Table | EUR |

The system may allow the user to modify the currency exchange rate or may obtain an updated rate from an external source in real time.

In a site creation process, a user may be permitted to select any device price table. On the other hand, in some instances, some access restriction may need to be placed on at least some device price tables. For example, one sales partner company may not wish users associated with another sales company to view and use their Device Price Table data. Accordingly, the system may set visibility restrictions on some (or all) of the device price data.

In the example encompassed by Table 9 (device table data), Table 10 (organization data) and Table 11 (device table to organization relationship), Device Table ID1 (i.e. Ricoh US Device Table) is accessible by Ricoh US and Ricoh Japan, Device Table ID2 (i.e. Ricoh Japan Devices) is accessible only by Ricoh Japan, and Device Table ID3 (i.e. Ricoh French Table) is accessible by Ricoh US, Ricoh Japan and Ricoh France.

TABLE 9
Device Table Data

| ID | Org ID | Table Name | Currency |
|---|---|---|---|
| 1 | 1 | Ricoh US Device Table | USD |
| 2 | 2 | Ricoh Japan Devices | JPY |
| 3 | 3 | Ricoh French Table | EUR |

TABLE 10
Device Table Data

| ID | Org Name | Country | Currency |
|---|---|---|---|
| 1 | Ricoh US | USA | USD |
| 2 | Ricoh Japan | Japan | JPY |
| 3 | Ricoh France | France | EUR |

TABLE 11
Device Table - Organization Relationship

| ID | Device Table ID | Org ID |
|---|---|---|
| 1 | 1 | 1 |
| 2 | 1 | 2 |
| 3 | 2 | 2 |
| 4 | 3 | 1 |
| 5 | 3 | 2 |
| 6 | 3 | 3 |

While such example employs access control based on e relationship between device tables and organizations, the access control may also (or alternatively be based on user access level.

The aforementioned specific embodiments are illustrative, and many variations can be introduced on these embodiments without departing from the spirit of the disclosure or from the scope of the appended claims. For example, elements and/or features of different examples and illustrative embodiments may be combined with each other and/or substituted for each other within the scope of this disclosure and appended claims.

For example, the order in which the steps are performed in the aforementioned methods is not limited to those shown in the examples of FIGS. 3 and 4, and may be modified as long as the desired result, or similar results, are achieved. Also, it should be noted that the methods illustrated in the examples of FIGS. 3 and 4 may be implemented using any of the embodiments shown in FIGS. 1A-1D.

What is claimed is:

1. An enterprise analysis application including one or more programs of instructions embodied in a non-transitory computer readable medium and executable by a computer to configure the computer to comprise:
a device data module that collects device data, including device price data, for a plurality of devices employed in an enterprise including a plurality of sites,
wherein the device data module forms and maintains plural device price tables to register the collected device price data in one or more storage devices, and the plural device price tables express the collected device price data in plural currencies corresponding to the plural device price tables; and
an analysis module that retrieves the device price data in the plural device price tables, performs an enterprise analysis based on the retrieved device price data, and outputs an enterprise analysis report reflecting the enterprise analysis.

2. The enterprise analysis application of claim 1, wherein the device data module registers, for each device price table amongst the plural device price tables, device table data associating the device price table with an associated currency amongst the plural currencies.

3. The enterprise analysis application of claim 1, wherein at least one device model is reflected in each of the device price tables in the respective currencies.

4. The enterprise analysis application of claim 1, wherein the plural device price tables having respective table identifiers correspond to respective sales companies.

5. The enterprise analysis application of claim 1, wherein for each device model reflected in the device price tables, the device price tables indicate device configuration corresponding to the device model.

6. The enterprise analysis application of claim 1, wherein for each device model reflected in the device price tables, the device price tables indicate prices of one or more of device options, device accessory and device consumables.

7. The enterprise analysis application of claim 1, further comprising an application user interface configured to output the price data to a user of the application user interface in a single currency associated with the user.

8. The enterprise analysis application of claim 7, wherein the application user interface registers user data associating each user, amongst plural registered users of the enterprise analysis application, with a particular device price table amongst the plural device price tables, and price data output to the user is obtained from the particular device price table to which the user is associated.

9. The enterprise analysis application of claim 7, wherein the application user interface registers organization data associating, for each particular organization amongst plural registered organizations, the particular organization with a corresponding currency and associating the particular organization with one or more of the device price tables, and registers user data associating, for each particular user amongst plural registered users, the particular user with an organization amongst the plural registered organizations.

10. The enterprise analysis application of claim 7, wherein the application user interface registers organization data associating, for each particular organization amongst plural registered organizations, the particular organization with one or more of the device price tables to which users associated with the particular organization have access.

11. The enterprise analysis application of claim 7, wherein the application user interface registers organization data associating, for each particular organization amongst plural registered organizations, the particular organization with a currency associated with the particular organization.

12. The enterprise analysis application of claim 7, wherein the application user interface registers table access data indicating, for said each specific user, the device price table to which the specific user has access.

13. The enterprise analysis application of claim 1, wherein the analysis module is configured to generate and output, for each site amongst one or more sites of the enterprise, a site analysis report, in response to a request of a user.

14. An enterprise analysis application including one or more programs of instructions embodied in a non-transitory computer readable medium and executable by a computer to configure the computer to comprise:
a device data module that collects device data, including device price data, for a plurality of devices employed in an enterprise including a plurality of sites disposed over plural countries,
wherein the device data module forms and maintains plural device price tables to register the collected device price data in one or more storage devices, and the plural device price tables express the collected device price data in plural currencies corresponding to the plural countries;
an enterprise analysis table associating the enterprise with a specified currency;
a site analysis table which, for each site amongst the plurality of sites of the enterprise, associates the site with a corresponding device price table and a corresponding currency and indicates a conversion rate to convert prices in the device price table associated with the site to the currency associated with the enterprise; and
an analysis module that retrieves the device price data in the plural device price tables, performs an enterprise analysis based on the retrieved device price data, and outputs an enterprise analysis report reflecting the enterprise analysis,
wherein all of the price data shown in the enterprise analysis report output by the analysis module is in the currency associated with the enterprise.

15. The enterprise analysis application of claim 14, wherein the analysis module is configured to generate and output, for each site amongst one or more specified sites of the enterprise, a site analysis report, and the site analysis report for a specified site shows prices in the currency associated by the site analysis table with the site.

16. The enterprise analysis application of claim 14, wherein in a case that the retrieved device price data for a particular site is in a local currency different than the currency associated with the enterprise, the analysis module converts the device price data in the local currency to price data in the currency associated with the enterprise by employing the conversion rate registered for the particular site in the site analysis table.

17. A method for performing an enterprise analysis of devices in an enterprise, the method comprising:
collecting device data, including device price data, for a plurality of devices employed in an enterprise including a plurality of sites, and maintaining plural device price tables to register the collected device price data in one or more storage devices, the plural device price tables expressing the collected device price data in plural currencies corresponding to the plural device price tables; and
retrieving the device price data in the plural device price tables, performing an enterprise analysis based on the retrieved device price data, and outputting an enterprise analysis report reflecting the enterprise analysis.

18. The method of claim 17, further comprising:
registering organization data associating, for each particular organization amongst plural registered organizations, the particular organization with a corresponding currency and associating the particular organization with one or more of the device price tables;
registering device table data associating, for each device price table amongst the plural device price tables, the device price table with an associated currency amongst the plural currencies; and
registering user data associating, for each particular user amongst plural registered users, the particular user with an organization amongst the plural registered organizations.

19. The method of claim 17, further comprising:
maintaining an enterprise analysis table associating the enterprise with a specified currency, and maintaining a site analysis table which, for each site amongst the plurality of sites of the enterprise, associates the site with a corresponding device price table and a corresponding currency and indicates a conversion rate to convert prices in the device price table associated with the site to the currency associated with the enterprise; and
in a case that the retrieved device price data for a particular site is in a local currency different than the currency associated with the enterprise, converting the device price data in the local currency to price data in the currency associated with the enterprise by employing the conversion rate registered for the particular site in the site analysis table.

20. The method of claim 17, further comprising:
registering organization data associating, for each particular organization amongst plural registered organizations, the particular organization with one or more of the device price tables to which users associated with the particular organization have access.
